(19) United States
(12) Patent Application Publication
(10) Pub. No.: US 2025/0289759 A1
(43) Pub. Date: Sep. 18, 2025

(54) CEMENT FREE ACTIVATED BINDER FOR CONSTRUCTION APPLICATIONS

(71) Applicant: Laticrete International Inc., Bethany, CT (US)

(72) Inventors: Jason Blanck, Oxford, CT (US); Randall Bright, Naugatuck, CT (US)

(21) Appl. No.: 18/859,839

(22) PCT Filed: Apr. 28, 2023
(86) PCT No.: PCT/US2023/020429

§ 371 Date: Oct. 24, 2024

Related U.S. Application Data
(60) Provisional application No. 63/336,087, filed on Apr. 28, 2022.

(51) Int. Cl. C04B 28/08; C04B 14/06; C04B 14/28; C04B 22/06; C04B 22/14; C04B 24/26; C04B 24/38; C04B 103/00; C04B 103/10; C04B 103/30; C04B 103/32; C04B 103/50; C04B 111/00; C04B 111/62

(52) U.S. Cl. CPC C04B 28/08; C04B 14/06; C04B 14/28; C04B 22/064; C04B 22/14; C04B 24/2635; C04B 24/386; C04B 2103/0054; C04B 2103/0079; C04B 2103/10; C04B 2103/302; C04B 2103/32; C04B 2103/50; C04B 2111/00637; C04B 2111/62

(57) ABSTRACT

Portland cement-free binder formulations, methods of making, and use of such cement-free binder formulations in building materials. The Portland cement-free binder formulations of the invention at least include a geopolymer material, preferably slag, present in an amount from about 90-98 wt. % of the binder formulation, an activator agent in an amount greater than 0 wt. % to less than 10 wt. %, and a slag accelerating agent in an amount from greater than 0 wt. % to less than 10 wt. % of the binder formulation. The activator agent may be hydrated lime, while the slag accelerating agent may be calcium dihydroxide and a calcium salt. The binder formulations of the invention may be premixed hydrated lime activated geopolymer-based binders for addition with the one or more additional compounds to render a building material composition.

### TECHNICAL FIELD

The present invention relates to construction materials and, more particularly, to cement free activated binders for use in construction materials.

### DESCRIPTION OF RELATED ART

Portland cement is widely used in the construction industry in binder compositions that are used to formulate cementitious compositions used in making products for joining tile, masonry and other types of building materials together, filling joints and voids between materials, etc. This type of cement is a hydraulic cement that is usually produced by heating limestone and clay minerals, which are eventually ground into a fine powder form. The low cost and widespread availability of the ingredients used to make Portland cement make it a cost-effective material that is commonly used in the production of concrete, mortars, grouts, plasters, block making, etc. However, the production of Portland cement is energy intensive and emits enormous amounts of carbon dioxide (CO₂) as well as numerous other pollutants. It can emit up to 1 ton of carbon dioxide for every 1 ton of Portland cement product.

In reducing the carbon footprint of Portland cement, use of geopolymers or pozzolan(s) have been introduced into the making of cementitious binder compositions whereby a portion of the Portland cement is replaced with one of these environmentally friendly materials. For instance, compositions have been developed that partially replace the Portland cement with geopolymer alternatives such as, fly ash or slag, both of which are by-products of other industries and would otherwise end up in landfills. Fly ash is a waste by-product of thermoelectric power plants, while slag is a waste by-product of blast furnaces in the ironworks industry (i.e., an industrial byproduct of the steel and iron manufacturing process). In these modified binder compositions, the geopolymer substitutes replace only a portion of the Portland cement so that the composition includes both a geopolymer and Portland cement. The inclusion of Portland cement provides the resultant compositions with hydraulic strength properties.

With known binder compositions still using an amount of Portland cement in their formulations, energy use and CO₂ emissions still continue to rise due to the continued need for the production of Portland cement. In view of the foregoing, there continues to be a need for new and improved construction binder compositions that avoid use of Portland cement, while still maintaining binder strength (i.e., hydraulic strength) and overall durability of end-product(s) made using such binder compositions (e.g., concrete, mortars, thin-set adhesives (thin-set mortars), grouts, self-leveling underlayments, patches, plasters, block making, and other cementitious construction materials), for which the present invention provides a solution thereto.

### SUMMARY OF THE INVENTION

Bearing in mind the problems and deficiencies of the prior art, it is therefore an object of the present invention to provide cement free binder compositions, particular, Portland cement free binder compositions suitable for use in products and applications that typically use or require cementitious binders and/or materials.

Another object of the present invention is to provide cement free binder compositions that environmentally friendly and reduce CO2 emissions during the manufacture thereof.

It is another object of the present invention to provide cement free binder compositions suitable for use in fabricating end-products including mortars, thin-set adhesives, grouts, self-leveling underlayments, concrete, patches, and the like, as well as to provide such end-products themselves.

Still other objects and advantages of the invention will in part be obvious and will in part be apparent from the specification.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a comparative table of slag-based binders of the prior art as compared to hydrated lime activated slag-based binders of the invention.

FIG. 2 is a table showing comparative thin-set adhesives based on the formulations of binders set forth in FIG. 1.

FIGS. 3A-3D depict plotted results of a tertiary study performed to determine optimal replacement amounts of hydrated lime.

FIG. 4A depicts graphed 1-day compressive strengths of prior art comparative samples containing WPC.

FIG. 4B depicts graphed 1-day compressive strengths of the present hydrated lime slag-based binders of the invention containing no WPC.

FIG. 5A depicts graphed 7-day compressive strengths of prior art comparative samples containing WPC.

FIG. 5B depicts graphed 7-day compressive strengths of the present hydrated lime slag-based binders of the invention containing no WPC.

FIG. 6A depicts graphed 28-day compressive strengths of prior art comparative samples containing WPC.

FIG. 6B depicts graphed 28-day compressive strengths of the present hydrated lime slag-based binders of the invention containing no WPC.

FIGS. 7A-7B respectively depict graphed water percentage usage of prior art samples containing WPC as compared to those of the invention containing no WPC.

FIGS. 8A-8B respectively depict plotted results of FIGS. 7A-7B showing the comparative plot trends.

FIGS. 9A-9B respectively depict graphed setting rates of prior art samples containing WPC as compared to those of the invention containing no WPC

### MODE(S) FOR CARRYING OUT INVENTION

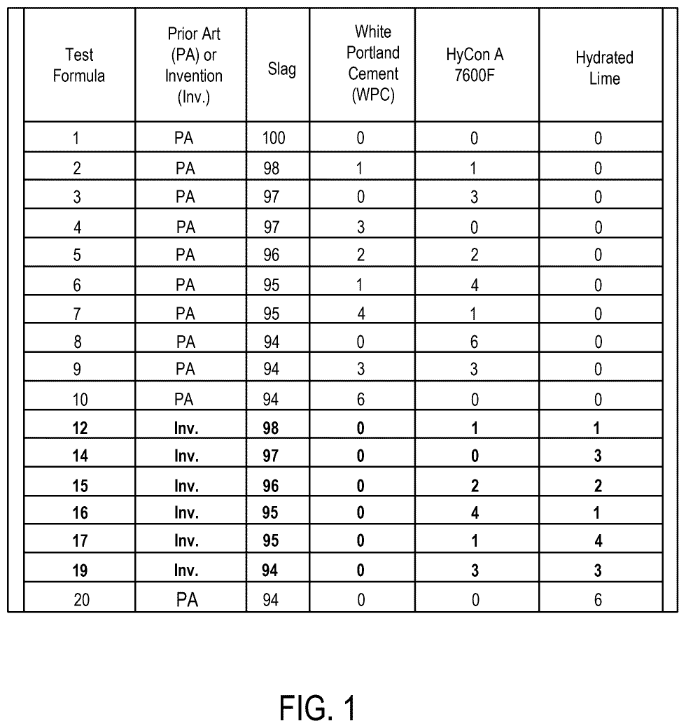

In describing the preferred embodiment of the present invention, reference will be made herein to FIGS. 1-9B of the drawings in which like numerals refer to like features of the invention.

The embodiments of the present invention can comprise, consist of, and consist essentially of the features and/or steps described herein, as well as any of the additional or optional ingredients, components, steps, or limitations described herein or would otherwise be appreciated by one of skills in the art. It is to be understood that all concentrations disclosed herein are by weight percent (wt. %.) based on a total weight of the composition or formulations being made, unless otherwise indicated.

The various embodiments of the invention provide cement free binders, particularly, Portland cement free binders suitable for use in construction and building materials. In one or more embodiments, the invention avoids the use of Portland cement by providing a slag-based binder system that utilizes slag as the major binder component in combination with a slag accelerating component and an alkaline activating component. While known binder systems may include a slag component in combination with a slag accelerating component, such systems also include use of white Portland cement (WPC) as the alkaline activating component. The invention is directed to one or more cement-free binders that avoid the use of WPC in order to reduce the detrimental effects thereof.

In accordance with the invention, cement free binders are provided that eliminate the need for cement, particularly Portland cement, by replacing the cement component with slag that has been activated by an alkaline activating component in combination with a slag accelerating component, without the use of Portland cement. In doing so, the present cement free binder systems are more environmentally friendly as compared to traditional cementitious binder materials as they utilize the waste by-product slag, which would otherwise be disposed of in landfills, and avoid the use of Portland cement thereby reducing CO₂ emission generated by its manufacture. Additional benefits of the present cement free binders include the usability and performance thereof. It has been found that conventional binders that include slag in combination with cement (Portland cement or WPC) in the formulation typically have issues related to setting times and limited early strength development. It has also been found that the alkali activators used in these conventional formulations, such as, caustic bases of NaOH, silicates of Na₂SiO₂, or sulfates of CaSO₄, either cause the binder to set too quickly which undesirably decreases workability time (even though set strength time is increased), or alternatively set too slow providing for sufficient workability time, yet prevent early strength development.

The present binder formulations of the invention provide cement-free binders that include slag (instead of Portland cement) in combination with a slag accelerator, including at least calcium dihydroxide and a calcium salt, and an alkaline slag activator comprising hydrated lime (instead of Portland cement or WPC). In one or more embodiments, the present cement free binder formulations include slag as the main binder component in an amount ranging from about 90-98 wt. %, with the remainder about 2-10 wt. % of the binder formulation comprising a combination of hydrated lime (Ca(OH)₂) as the alkaline slag activator and a slag accelerator comprising at least calcium dihydroxide in combination with a calcium salt, wherein weight percent (wt. %) is based on a total weight of the binder formulation. It has been found that the resultant lime activated slag-based binders of the invention have sufficient hydraulic strength, and the setting of the instant binders allows for both ease of usability and suitable early strength development for construction material applications. In particular, the present cement free lime activated slag-based binders have been found to be suitable for use as construction building materials including, but not limited to, tile adhesives, mortars, thin-set mortars, self-leveling underlayments, thin-set adhesives, grouts, patches, and other cementitious construction materials.

In more detail, in one or more embodiments the invention is directed to hydrated lime activated slag-based binder formulations that include no Portland cement (i.e., Portland cement free binders). The binder formulations include a main binder component in combination with a secondary binder component and an accelerator. The main binder component is a geopolymer, preferably slag, that is activated by the secondary binder using a slag accelerator agent. In one or more embodiments, the main binder includes a bulk slag selected from granulated ground blast furnace slag (GGBFS), also referred to as BFS ground granulated blast furnace slag, blast furnace slag, slag type 120, ferrous metal slag, or finely ground GGBFS (ground to a fine powder) sold under the tradename NewCem manufactured by Holcim).

The secondary binder is selected from binders capable of interacting and activating the slag main binder component. Preferably the secondary binder is hydrated lime comprising Ca(OH)₂ (calcium hydroxide), calcium-magnesium hydroxide, dolomitic hydrated lime, dolomitic calcium hydroxide, >50% calcium hydroxide, or >35% magnesium hydroxide. Exemplary hydrated lime includes hydrated lime type S or hydrated lime type N. The use of hydrated lime as the activating component avoids use of the conventional caustic compounds and liquid silicates, provides sufficient workability time, avoids early strength development, forms stable hydration phases, and is generally environmentally friendly.

The slag and hydrated lime are combined with a slag accelerator component that is capable of interacting with the slag. In one or more embodiments, the slag accelerator comprises a composition that at least includes a calcium dihydroxide in combination with a calcium salt. In various preferred embodiments, the slag accelerator comprises calcium dihydroxide in combination with calcium disulphamate (calcium sulfamate), and optionally additional constituents. In these embodiments, it has been found that calcium dihydroxide in combination with calcium disulphamate to be particularly well suited in interacting with and activating the slag component to provide the slag with increased hydraulic strength. In one or more embodiments the slag accelerator may at least include about 10-60 wt. % calcium disulphamate and 1-20 wt. % calcium dihydroxide. It has been found that a suitable slag accelerator is sold under the tradename Hycon A 7600 F manufactured by BASF.

In accordance with one or more embodiments, the present hydrated lime activated slag-based binders may be mixed together to form a premixed binder for addition with other chemical compounds for rendering various construction building materials or end-products (e.g., tile adhesives, mortars, thin-set mortars, self-leveling underlayments, thin-set adhesives, grouts, patches, etc.). Alternatively, the ingredients within the present hydrated lime activated slag-based binders may directly be combined individually with other chemical compounds for rendering such various construction building materials.

In those embodiments directed to a premixed slag-based binder itself (i.e., a binder that is added with other components/ingredients/compounds to render a building end-product), ratios of the ingredients may range from the slag main binder component being present in the premixed binder in an amount ranging from about 90-98 wt. %, the hydrated lime being present in an amount ranging from about 1-9 wt. %, and the calcium dihydroxide/calcium salt being present in an amount ranging from about 1-9 wt. %, wherein weight percent is based on a total weight of the premixed slag-based binder.

In alternate embodiments of the invention, the separate slag-based binder components of the invention may be provided in construction end-products in ranges from about 15-50 wt. % slag component, about 1-20 wt. % hydrated lime component, and about 0.25-5 wt. % slag accelerator, based on a total weight of the end-product formulation, with the remaining ingredients comprising various materials used to make up the particular construction end-product(s). It should be appreciated that in such end-product formulations, the amount of slag to hydrated lime activator to calcium dihydroxide/calcium salt accelerator remains in weight percentages with respect to the slag-based binder formed by this combination in ranges of 90-98 wt. % slag to 1-9 wt. % hydrated lime to 1-9 wt. % slag accelerator.

In those embodiments of the invention where the instant binder components are mixed with materials to render construction end-products, various additional materials may be added to the present lime activated slag binder composition(s) to provide a resultant formulation having one or more desired qualities for rendering a construction end-product as discussed herein. For instance, the various formulations may include performance additives combined with the instant slag binders. The performance additives may include a dispersible powder copolymer present in an amount from equal to or greater than 0 wt. % to 10 wt. % (preferably 1-10 wt. %). For instance, a suitable dispersible powder copolymer may be a powdered vinyl acetate ethylene copolymer (e.g., Vinnapas 5010N or Vinnapas 5044N manufactured by Wacker Chemie AG).

One or more rheological modifier additives may also optionally be included in the various formulations each in amounts ranging from equal to or greater than 0 wt. % to 1 wt. % (preferably 0.01-1 wt. %). The rheological modifier may include cellulose ether, such as, a material designed for cementitious material, modified hydroxypropyl methyl cellulose ether, hydroxypropyl ethyl cellulose ether, and the like. Exemplary cellulose ethers may include cellulose ether (e.g., sold under the tradename Walocel 254 manufactured by Dow), modified hydroxypropyl methyl cellulose ether (e.g., sold under the tradename Walocel MK 3000 PF manufactured by Dow), and/or hydroxypropyl ethyl cellulose ether (e.g., sold under the tradename Walocel MKX 70000 PP 01 manufactured by Dow). Another rheological modifier may include dituan gum-based viscosity modifier (e.g., Kelco-crete DG-F or Kelcocrete DG manufactured by CP Kelco).

Water reducing agents may be added to the various formulations in amounts of equal to or greater than 0 wt. % to 1 wt. %, preferably 0.01-1 wt. %, to enhance product flow or flowability. Suitable water reducer/flow additives include superplasticizers, such as, polycarboxylate ether, melamine sulfonates, naphthalene sulfonates, and/or lignosulfonates (e.g., Compac 149S manufactured by Imerys S. A., Melflux 2561 or Melflux 6681 both manufactured by BASF, Lomar D manufactured by GEO, and the like). Optionally, one or more defoamers may also be added to the various formulations of the invention in amounts of equal to or greater than 0 wt. % to 1 wt. %, preferably 0.01-1 wt. %, based on the total weight of such formulation. A suitable defoamer may include a powdered additive of hydrocarbons and polyglycols on an inorganic carrier (e.g., Agitan P809 manufactured by Münzing Corporation).

Different aggregates may also be added to the various formulations of the invention. For instance, limestone (such as, crushed limestone of 325 mesh particle size (e.g., Dolocron 45-12 manufactured by Prospector)) may be added in an amount of equal to or greater than 0 wt. % to 10 wt. %. Fine to medium grade sand (e.g., 100 to 50 mesh sand), or even coarse sand (e.g., 35 mesh), may be added in an amount ranging from 30-70 wt. %, and varying amounts therebetween.

Optionally, one or more additional accelerating components may be added to the various construction end-product formulations made in accordance with the invention. These additional accelerators may be added alone or in various combinations thereof, each in amounts ranging from equal to or greater than 0 wt. % to 10 wt. %, preferably 0.01-10 wt. %, based on the total weight percentage of such resultant end-product formulation(s). Suitable additional accelerating materials include, but are not limited to, sodium silicate, sodium hydroxide, sodium carbonate, potassium silicate, potassium hydroxide, potassium carbonate, organic calcium salts (e.g., calcium acetate, calcium formate, calcium sulfamate, etc.), calcium sulfate (e.g., gypsum including (anhydrous, hemihydrate, and dihydrate types)), and the like.

Again, the present Portland cement free alkali activated slag-based binders of the invention may be a premixed composition that is added to other ingredients in making building materials or end-products, or alternatively, the various components of the present slag-based binders may be added separately in formulating such building material end-products. Various building material end-product formulations incorporating the present slag-based binder are encompassed by the invention. In one or more embodiments end-product formulations may include, but are not limited to, tile adhesives, mortars, thin-set mortars, self-leveling underlayments, thin-set adhesives, grouts, patches, and the like.

In accordance with one or more embodiments, the invention is directed to tile adhesive (thin-set adhesive) formulations that include slag in an amount of about 15-50 wt. %, hydrated lime in an amount of about 1-20 wt. %, and a slag accelerator (preferably a slag accelerator including calcium dihydroxide and calcium disulphamate) in an amount of about 0.25-5 wt. %. The adhesive formulations may further include a redispersable powdered copolymer of vinyl acetate ethylene in an amount of equal to or greater than 0 wt. % to 10 wt. %, cellulose ether in an amount of equal to or greater than 0 wt. % to 1 wt. % (preferably 0.01-1 wt. %), limestone (preferably crushed aggregate) in an amount of equal to or greater than 0 wt. % to 10 wt. % (preferably 1-10 wt. %), and sand (aggregate) in an amount of about 40-70 wt. %, based on a total weight of the tile adhesive formulation.

Alternate embodiments of the invention are directed to mortar bed formulations that include slag in an amount of about 15-50 wt. %, hydrated lime in an amount of about 1-20 wt. %, slag accelerator (preferably a slag accelerator including calcium dihydroxide and calcium disulphamate) in an amount of about 0.25-5 wt. %, a dispersible powder copolymer in an amount of equal to or greater than 0 wt. % to 10 wt. % (preferably 1-10 wt. %), cellulose ether in an amount of equal to or greater than 0 wt. % to 1 wt. % (preferably 0.01-1 wt. %), limestone (preferably 325 mesh crushed aggregate) in an amount of equal to or greater than 0 wt. % to 10 wt. % (preferably 1-10 wt. %), and sand (preferably coarse sand 35 mesh) in an amount of about 40-70 wt. %, based on a total weight of the mortar bed formulation.

Embodiments of the invention are also directed to Self-Leveling Underlayment (SLU) materials or formulations. In these embodiments, the SLUs may include slag in an amount of about 15-50 wt. %, hydrated lime in an amount of about 1-20 wt. % (preferably hydrated lime type S, hydrated lime type N), and slag accelerator (preferably a slag accelerator including calcium dihydroxide and calcium disulphamate (e.g., Hycon A 7600 F) in an amount of about 0.25-5 wt. %. The SLUs may further include a performance additive of redispersable powdered copolymer of vinyl acetate ethylene in an amount of equal to or greater than 0 wt. % to 10 wt. % (preferably 0.01-10 wt. %), a first rheological modifier of cellulose ether in an amount of equal to or greater than 0 wt. % to 1 wt. % (preferably 0.01-1 wt. %), a second rheological modifier of dituan gum-based viscosity modifier in an amount of equal to or greater than 0 wt. % to 1 wt. % (preferably 0.01-1 wt. %), a water reducer, flow additive such as a superplasticizer in an amount of equal to or greater than 0 wt. % to 1 wt. % (preferably 0.01-1 wt. %), a defoamer such as a powdered additive of hydrocarbons and polyglycols on an inorganic carrier in an amount of equal to or greater than 0 wt. % to 1 wt. % (preferably 0.01-1 wt. %), and sand (fine to medium grade aggregate) in an amount of about 30-70 wt. %, based on a total weight of the tile adhesive formulation.

Optionally, the SLUs of the invention may further include one or more additional accelerating components, which may be added alone or in various combinations thereof, in amounts of each component ranging from equal to or greater than 0 wt. % to 10 wt. %, preferably 0.01-10 wt. %. Exemplary suitable additional accelerating components include sodium silicate, sodium hydroxide, sodium carbonate, potassium silicate, potassium hydroxide, potassium carbonate, organic calcium salts, calcium sulfate, and the like.

Additional embodiments of the invention include grout formulations that include slag in an amount of about 15-50 wt. %, hydrated lime in an amount of about 1-20 wt. % (preferably hydrated lime type S, hydrated lime type N), and slag accelerator (preferably a slag accelerator including calcium dihydroxide and calcium disulphamate (e.g., Hycon A 7600 F) in an amount of about 0.25-5 wt. %. The grouts may also include a performance additive of a dispersible powder copolymer (e.g., a powdered copolymer with hydrophobic characteristics) in an amount of equal to or greater than 0 wt. % to 10 wt. % (preferably 0.01-10 wt. %), a first rheological modifier of cellulose ether in an amount of equal to or greater than 0 wt. % to 1 wt. % (preferably 0.01-1 wt. %), a second rheological modifier of dituan gum-based viscosity modifier in an amount of equal to or greater than 0 wt. % to 1 wt. % (preferably 0.01-1 wt. %), a water reducer, flow additive such as a superplasticizer in an amount of equal to or greater than 0 wt. % to 1 wt. % (preferably 0.01-1 wt. %), a defoamer such as a those described herein in an amount of equal to or greater than 0 wt. % to 1 wt. % (preferably 0.01-1 wt. %), limestone (preferably 325 mesh crushed aggregate) in an amount of equal to or greater than 0 wt. % to 10 wt. % (preferably 1-10 wt. %), and sand (fine to medium grade aggregate) in an amount of about 30-70 wt. %, based on a total weight of the tile adhesive formulation. The grout formulations may further optionally include one or more additional accelerating components as described herein in amounts of each component ranging from equal to or greater than 0 wt. % to 10 wt. %, preferably 0.01-10 wt. %.

The invention is also directed to patch formulations that include slag in an amount of about 15-50 wt. %, hydrated lime in an amount of about 1-20 wt. % (preferably hydrated lime type S, hydrated lime type N), slag accelerator (preferably a slag accelerator including calcium dihydroxide and calcium disulphamate (e.g., Hycon A 7600 F) in an amount of about 0.25-5 wt. %. The patch formulations may also include a performance additive of a dispersible powder copolymer (e.g., a powdered copolymer with hydrophobic characteristics) in an amount of equal to or greater than 0 wt. % to 10 wt. % (preferably 0.01-10 wt. %), a first rheological modifier of cellulose ether in an amount of equal to or greater than 0 wt. % to 1 wt. % (preferably 0.01-1 wt. %), a second rheological modifier of dituan gum-based viscosity modifier in an amount of equal to or greater than 0 wt. % to 1 wt. % (preferably 0.01-1 wt. %), a water reducer, flow additive such as a superplasticizer in an amount of equal to or greater than 0 wt. % to 1 wt. % (preferably 0.01-1 wt. %), and a defoamer such as a those described herein in an amount of equal to or greater than 0 wt. % to 1 wt. % (preferably 0.01-1 wt. %). The patch formulations include limestone (preferably crushed limestone) in an amount of equal to or greater than 0 wt. % to 10 wt. % (preferably 1-10 wt. %), and sand (fine to medium grade aggregate (5000-7000 microns)) in an amount of about 30-70 wt. %, based on a total weight of the tile adhesive formulation. The grout formulations may further optionally include one or more additional accelerating components as described herein in amounts of each component ranging from equal to or greater than 0 wt. % to 10 wt. %, preferably 0.01-10 wt. %.

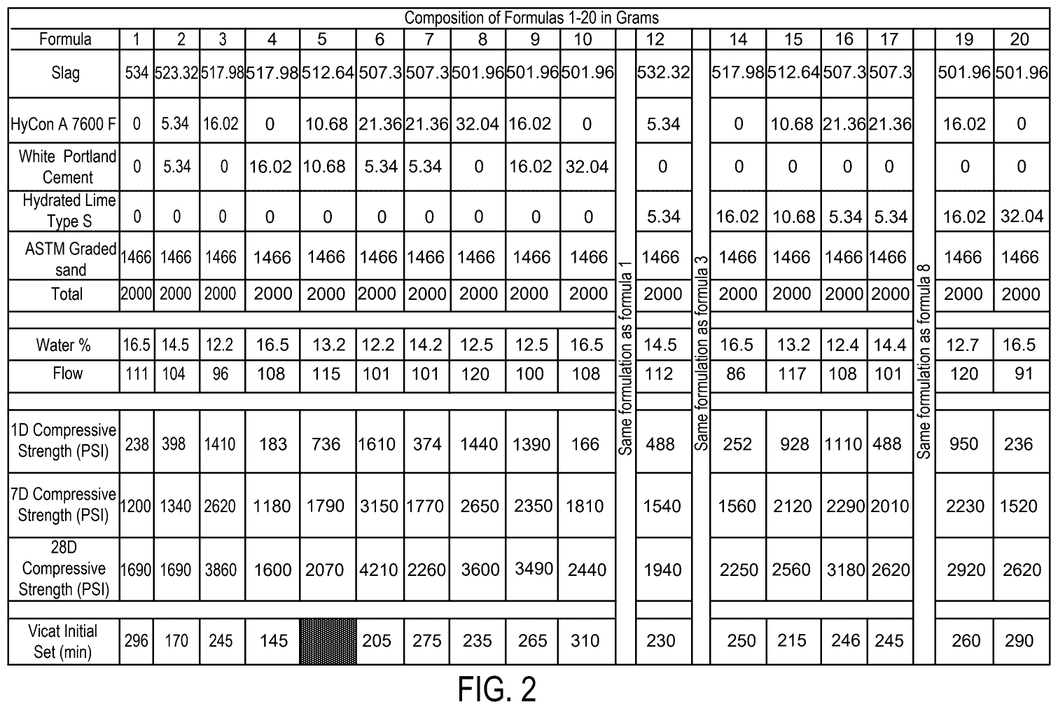

While not meant to be limiting, various exemplary thin-set adhesive formulations of the invention including the present Portland cement free alkali activated slag-based binders were prepared and compared to known slag-based binders which Portland cement (particularly White Portland Cement “WPC”) as an activator. As described herein, the slag-based binders of the invention have no Portland cement, such that they are cement-free binders whereby a Portland cement component has been entirely replaced with hydrated lime. Referring to FIGS. 1-2, FIG. 1 is a table depicting varying formulations of known Portland cement based/containing slag-based binders (denoted in the table as “PA”) as compared to the present hydrated lime activated slag-based binders of the invention (denoted in the table as “Inv.”) which include hydrated lime Type S as a WPC replacement acting as an activator. The alkaline hydrated lime raises the pH of the mixture to enhance dissolution of the amorphous phase of slag and encourage a hydration reaction of slag. These different comparative formulations were used to make different comparative thin-set adhesive samples set forth in the table shown in FIG. 2.

The comparative test samples of FIG. 2 where prepared in 2000 g batches in powder form where the individual ingredients were weighed up in a 1-gallon pail and mixed in a paint shaker for 2 minutes and 30 seconds at least one day prior to testing. The powdered samples were comprised of the varying comparative slag-based binders, and ASTM graded sand at a ratio of 1 part binder to 2.75 parts sand as directed in ASTM C109-11. Water was added to the various powdered samples and using an electric drill equipped with a paddle mixer, the samples were mixed for sixty seconds, followed by a ninety second slake, and finally another sixty second mix, attempting to replicate the mixing times described in ASTM C109. The mixed samples were then taken directly to the flow table following mixing where a flow test was conducted according to ASTM C109. Flow testing was performed on the samples, followed by producing six 2 in×2 in compressive strength cube samples and allowing them to cure, as well as filling a 4 oz cup for testing set times using an automatic Vicatronic Automatic Vicat Reader and recording set measures following a 120-150-minute delay, sampling every 10 minutes forty-one times for a total of 530-560 minutes.

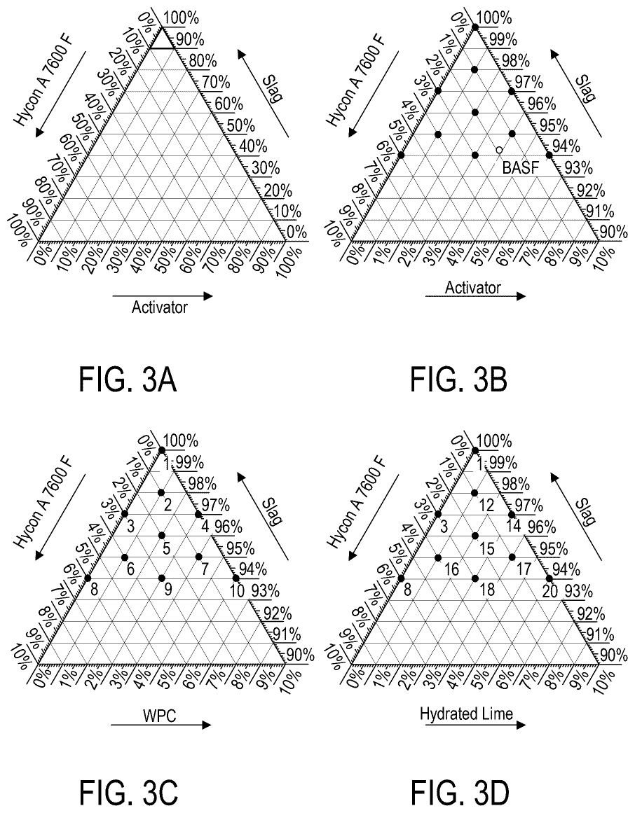

Referring to FIGS. 3A-3D, in order to determine replacement amounts of hydrated lime for WPC in the present invention, a tertiary study was performed testing several different ratios of slag, accelerator, and activator using both OPC and Hydrated Lime Type S as the activator. FIG. 3 A highlights the area of interest for which the tertiary study was performed, and FIG. 3B depicts locations of ternary compositions of the comparative binder tested as well as the ratios recommended via a thin-set formulation from BASF. FIGS. 3C and 3D depicted the plotted tertiary study results of the prior art WPC containing binders (FIG. 3C) and the Portland cement free hydrated lime activated binders of the invention (FIG. 3D). In these studies, only seventeen (17) samples were tested as three (3) of the samples (i.e., samples 1, 3 and 8) were used for both the WPC and hydrated lime binder activator studies, as these formulas only contained HyCon A 7600 F (hereinafter “HyCon”) and slag or simply slag.

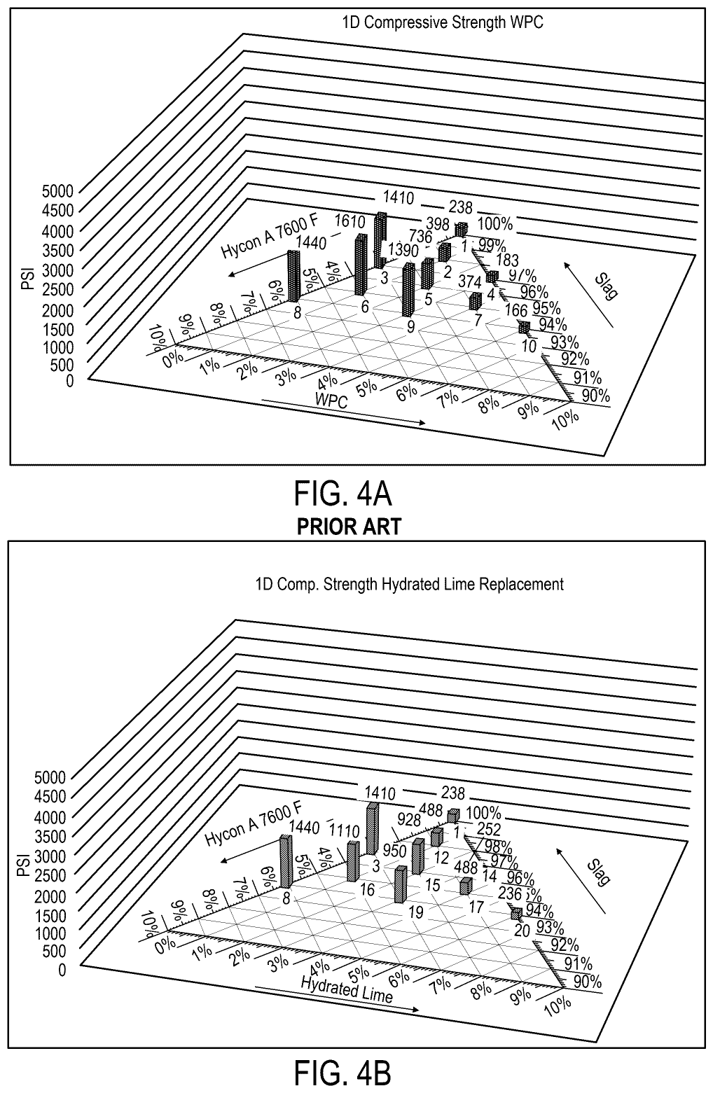

Compressive stresses of the tested comparative samples were measured at intervals of 1-day (“1-D”), 7-days (“7-D”), and 28-days (“28-D”). Referring to the comparative 1-day compressive strengths of FIGS. 4A and 4B depicting plots of the prior art samples containing WPC and the inventive hydrated lime slag-based binders, it was found that an increased percentage of the slag accelerator (i.e., HyCon) substantially increased the compressive strength for both all samples. It was found that all samples containing a HyCon percentage above 2% developed 1-D compressive strength above 700 PSI, and those samples containing no HyCon (i.e., Samples 1, 4, 10, 14 and 20) developed little early strength with no sample raising above 252 PSI. Samples 2, 7, 12, and 17, which possessed 1 percent HyCon A 7600 F, developed greater strength than those with no HyCon but strength was below 500 PSI. Samples 5 and 15 having 2% HyCon developed strengths of 736 PSI and 928 PSI, indicated of substantial strength gain at a low percentage of HyCon usage. The samples that had a percentage of HyCon between 3% and 6% for the Portland cement series of samples developed strength between 1390 PSI and 1610 PSI, while the samples of the present hydrated lime binder in the same HyCon range reached a strength of 950 PSI to 1440 PSI at 1-D. These results are indicative that HyCon has a substantial impact on generating 1-D compressive strengths even at dosages as low as 1%, making it a very effect slag accelerator at low dosages

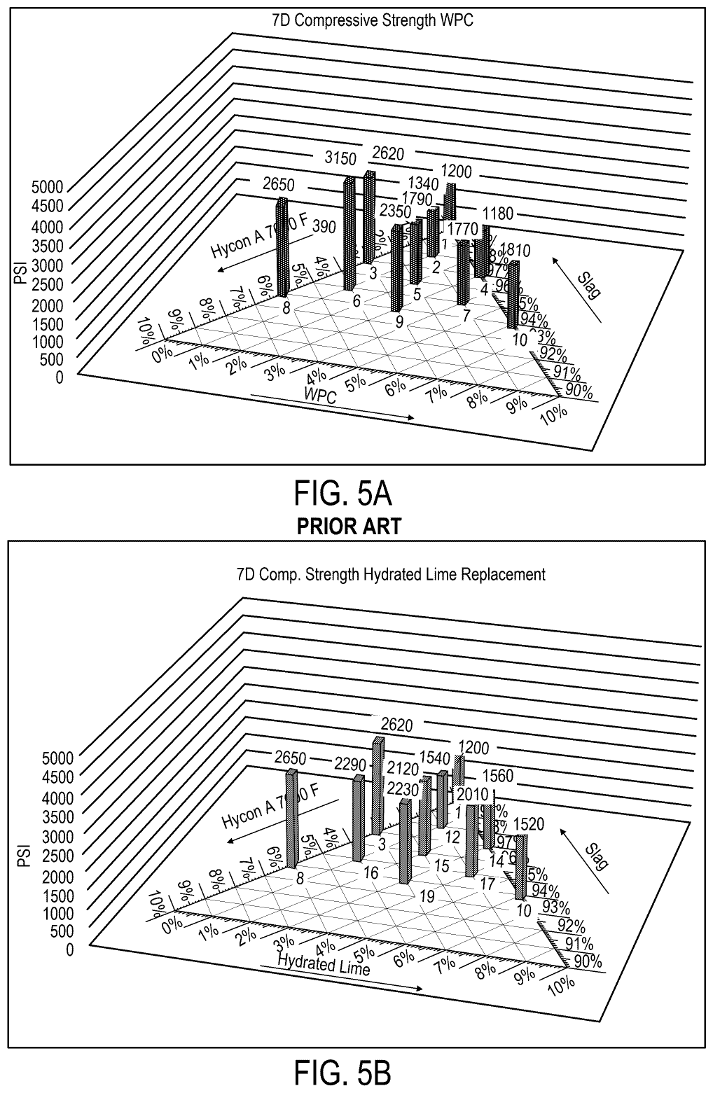

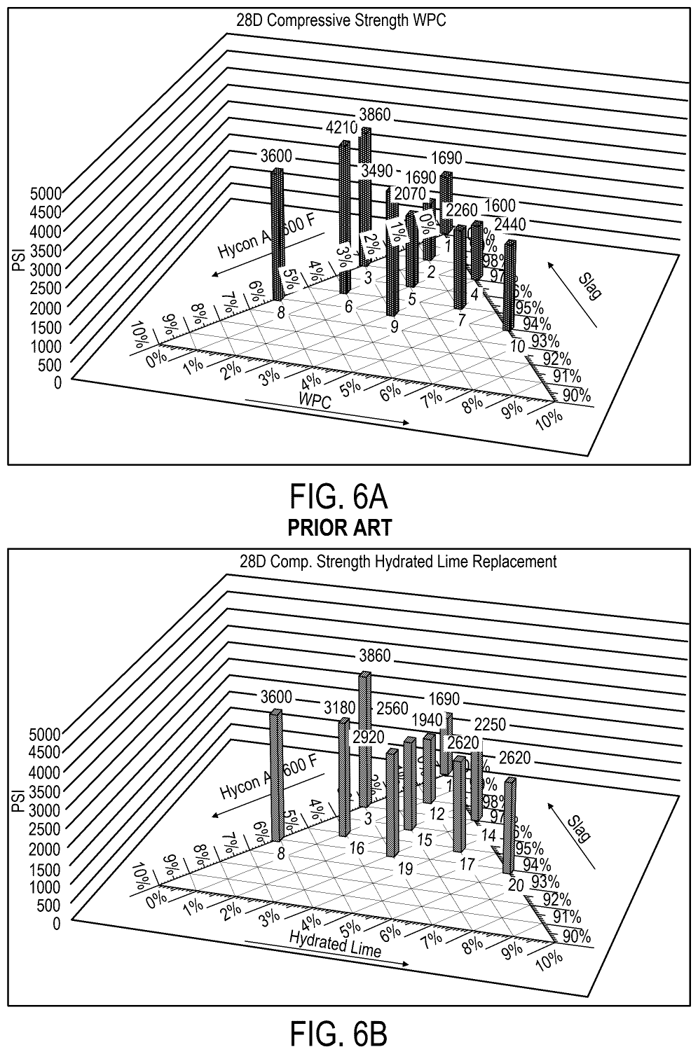

FIGS. 5A and 5B respectively depict plots of the comparative 7-day compressive strengths, while FIGS. 6A and 6B depict plots of the comparative 28-day compressive strengths, respectively. It was found that the majority of samples containing HyCon performed better than those without HyCon, and those samples having greater than 3% HyCon and hydrated lime as an activator, samples 16 and 19, producing sufficient strengths of 3180 PSI and 2920 PSI. The results show that use of HyCon at low dosages of 1% and 2% had a substantial impact on early strength development compared to the formulas with no HyCon present; however, the compressive strength development of these formulas became more comparable to formulas with no HyCon at 7-D and 28-D. Samples having HyCon at an amount over 3% of the binder will increase both substantial strength gains at 1D that far exceeded those without HyCon, and exhibited compressive strengths that exceeded those without HyCon present even at 7-D and 28-D. As such, use of HyCon at an amount over 3% of the binder will increase the 28-D compressive strengths of the binder compared to formulations with it absent or included at a lower percentage.

In referring the effect of alkaline activator on strength development at equal HyCon percentages (see FIG. 2 chart), it has been found that in the tested sample formulas having 1% HyCon and varying slag to activator ratios, the present hydrated lime slag-based binders (samples/formulas 12, 15 and 17) exhibited improved compressive strengths for 1-D, 7-D and 28-D strengths as compared to the prior art WPC formulas (samples/formulas 2, 5 and 7). Based on these tested samples, it has been found that formulas/samples containing equal to or less than 3% HyCon provided greater strengths when combined with the hydrated lime (i.e., no WPC) as compared to the prior art combined with WPC. The opposite was found for the comparative formulas containing greater than 3% HyCon (see, e.g., formulas 6 and 16). As such, in accordance with one or more embodiments of the invention the various hydrated lime slag-based binders may contain less than 3% HyCon in combination with slag and hydrated lime. However, in other embodiments the results still demonstrated hydrated lime as an effective alkali activator with greater than 3% HyCon provide sufficient compressive strength 28-days out (see, e.g., formulas 16 and 19). From the compressive strength studies, it was found that hydrated lime is an efficient substitute for WPC especially in formulations containing HyCon at 2% and below. Yet even though strengths of WPC formulas were stronger at amounts of 3% and above as compared to the present hydrated lime slag-based binders, it was still found that compressive strengths of the instant hydrated lime slag-based binders at amounts of 3% and above provided sufficient compressive strength 28-days out, making hydrated lime suitable for entirely replacing WPC in slag-based binders.

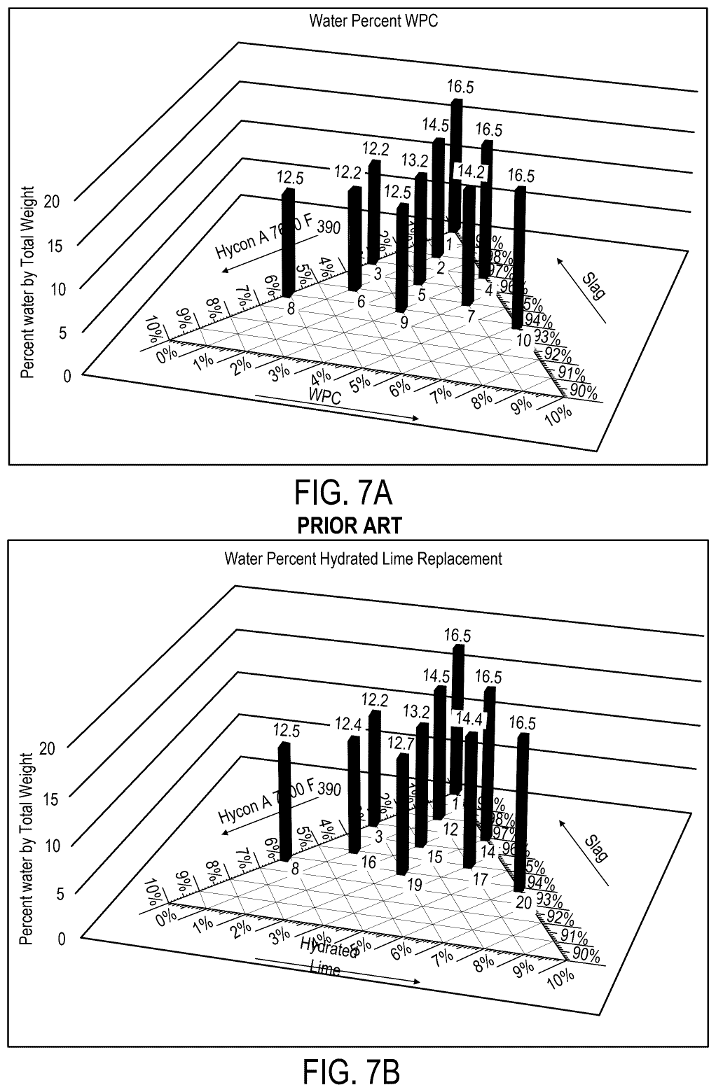

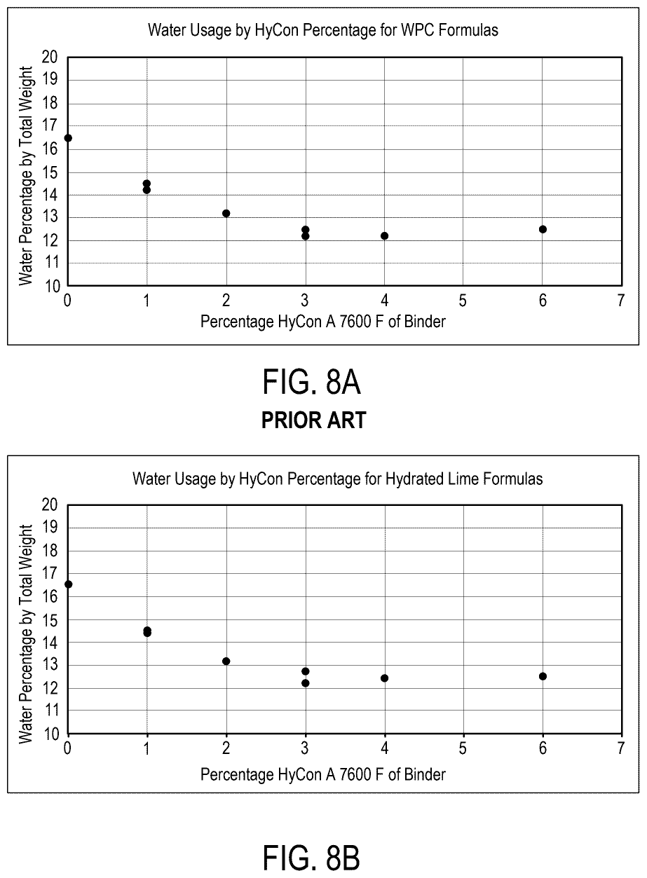

Referring to FIGS. 7A-7B water percentage used to achieve desired flow is depicted for both the prior art WPC tested samples as compared to the tested samples having hydrated lime slag-based binders. FIGS. 8A-8B show the plasticizing effectiveness of the prior art HyCon with WPC as compared to the inventive HyCon with hydrated lime binders. The water used for each sample was to be determined based off a flow reading. It has been found that hydrated lime is a suitable replacement for all of the WPC in conventional binders as it provides for a sufficient plasticizing effect. The plots of FIGS. 8A and 8B show comparable plot trends of percentage of HyCon and percentage of water used for the compared prior art formulas and inventive formulas, with the slope of the points ranging from 0% to 3% HyCon being much steeper than that at 3% to 6% HyCon. Based on this data, it has been found that replacement of WPC with the present slag-HyCon-hydrated lime binders of the invention provide comparable results, with a maximum plasticizing effect being detected at a level of 3% of the binder, and therefore would provide similar viscosity and workability at identical water percentages.

FIGS. 9A and 9B depict graphs of setting rates for the prior art WPC tested samples (FIG. 9A) as compared to the present hydrated lime slag-based binders (FIG. 9B) using an automatic Vicat. The results demonstrate that formulas containing WPC and hydrated lime preformed similarly, with an average initial set time for hydrated lime binders of 251.2 minutes and average initial set time for WPC binders of 238.4 minutes. In addition, the set times indicate a good working time that is on average 3-4 hours long.

It has been found that hydrated lime as an alkaline activating agent in combination with slag and a slag accelerator (i.e., accelerates strength development of the slag) that includes calcium dihydroxide and calcium disulphamate forms an acceptable binder. That is, hydrated lime is an acceptable alternative to, or replacement of, WPC and may entirely replace WPC in slag-based binders. In one or more embodiments, it was found that the present binders containing less than 3% hydrated lime developed earlier compressive strengths as compared to prior art WPC samples/formulas. It was also found that the present hydrated lime slag-based binders provide sufficient compressive strengths at 7-D and 28-D, some over 3000 PSI. The present invention provides cement free slag-based binders that are even suitable when the slag accelerator is used at percentages as low as 1% of the binder to provide acceptable 1-D strengths of 488 PSI (i.e., sample 12). The binders of the invention have been found to formulate acceptable building construction products (e.g., cementitious products) with a Portland cement free binder thereby reducing the carbon footprint as well as minimizing waste.

While not meant to be limiting, as an exemplary embodiment a thin-set tile adhesive of the invention was formulated using a hydrated lime slag-based binder of the invention, and was compared to a prior art adhesive formulated using WPC (i.e., 253 Gold white manufactured by LATICRETE International, Inc.). The tested comparative formulations for the prior art Portland cement containing binder using 253 Gold white and the tile adhesive of the invention using a Portland cement free binder comprising slag-HyCon-hydrated lime are depicted below in Table 1. As shown, the present invention replaces both the white Portland cement and the calcium formate, respectively, with a slag accelerator containing calcium dihydroxide and calcium disulphamate (in particular, HyCon A 7600F) and hydrated lime.

Table 1: The ratio of the ingredients within the below hydrated lime slag-based binder itself comprise 94.35% slag, 1.87% HyCon, and 3.78% hydrated lime, based on a wt. % of the total weight of the binder itself. This hydrated lime slag-based binder replaced the binder system present in the prior art Portland cement containing binder using 253 Gold white in 1:1 ratio. The prior art WPC-based binder (“WPC”) and the inventive slag-based binder (SBB) were both provided into a cementitious thin-set powder (particularly, 253 Gold manufactured by LATICRETE International, Inc., which is a polymer fortified bagged cementitious thin-set powder) and mixed with water to form thin-set adhesives for installing tile and/or stone.

Formulations

| Material | WPC-P.A. | SBB-Inv. |
|---|---|---|
| White Portland Cement Bulk | 19.70 wt. % | 0.00 wt. % |
| Calcium Formate | 0.18 wt. % | 0.00 wt. % |
| BULK SLAG | 8.41 wt. % | 26.69 wt. % |
| Hydrated Lime Type S | 0.00 wt. % | 1.07 wt. % |
| HYCON A 7600 F | 0.00 wt. % | 0.53 wt. % |
| BULK LIMESTONE | 7.00 wt. % | 7.00 wt. % |
| VINNIAPAS 5010N | 2.75 wt. % | 2.75 wt. % |
| Methocel 254 | 0.32 wt. % | 0.32 wt. % |
| MEDIUM SAND | 61.64 wt. % | 61.64 wt. % |
| TOTAL | 100.00 wt. % | 100.00 wt. % |
| WATER | 22.90 wt. % | 22.90 wt. % |
| Rough COST (cents/lb.) | 11.516 | 12.683 |

The two formulas were tested according to ANSI A118.4 Standard for Modified Dry Set Cement Mortar and ANSI A118.11 Standard for EGP Modified Dry-set Mortar. The results are set forth below in Tables 2-4 which show demonstrated shear strength results (Table 2), open time results (Table 3), and heliopath viscosity results (Table 4). Referring to Table 2, the shear strength measures of the WPC-Prior Art (“WPC-P.A.”) formula and the SBB-Inventive/Invention formula (“SBB-Inv.”) are compared to the ANSI A 118.4 Shear Strength Standards for various days (“STD”). These results establish that the present inventive tile adhesive (SBB) exceeded the ANSI A118.4 and A118.11 standards for shear strength, making it a suitable alternative or substitute for the WPC-Prior Art formulas. Table 3 shows that the present inventive tile adhesive (SBB) also exceeded the ANSI A118.4 standard for open time at 20 and 30 minutes. Also, referring to Table 4, at an identical water percentage of 22.90 percent by weight for the present inventive tile adhesive (SBB) and the WPC-Prior Art (“WPC-P.A.”) formula, such formulas exhibited near identical viscosities. As such, these results demonstrate the feasibility of developing Portland cement free products utilizing the slag-HyCon-hydrated lime binders of the invention as a substitution for Portland cement based binders.

TABLE 2
ANSI A118.4 and ANSI A118.11 Shear strength Results.
ANSI A 118.4 and A.118.11 Shear Strength Table (PSI)

| | | |
|---|---|---|
| STD | WPC-P.A. | SBB-Inv. |

ANSI A118.4 Wall Tile/Wall Tile Shear Strength

| | | | |
|---|---|---|---|
| 7 day sc wall tile/wall tile shear | 300 | 566 | 406 |
| 7 day sc 7 day wi wall tile/wall tile shear | 200 | 408 | 348 |
| 14 day sc 14 day 70C wall tile/wall tile shear | | 786 | 649 |

ANSI A118.4 Porcelain/Porcelain Shear Strength

| | | | |
|---|---|---|---|
| 1 day sc porcelain tile/porcelain tile shear | 75 | 193 | 107 |
| 7 day sc porcelain tile/porcelain tile shear | 200 | 400 | 325 |
| 7 day sc 7 day wi porcelain | 150 | 255 | 260 |
| tile/porcelain tile shear | | | |
| 28 day sc porcelain tile/porcelain tile shear | 200 | 450 | 351 |
| 28 day sc 20 f/t cycles porcelain | 175 | 350 | 259 |
| tile/porcelain tile shear | | | |
| 14 day sc 14 day 70C porcelain | | 406 | 391 |
| tile/porcelain tile shear | | | |

ANSI A118.4 Quarry to Quarry Shear Strength

| | | | |
|---|---|---|---|
| 28 day sc quarry tile/quarry tile shear | 150 | 401 | 377 |
| 28 day sc 20 cycles f/t quarry | 100 | 369 | 381 |
| tile/quarry tile shear | | | |

ANSI 118.11 Quarry to Plywood Shear Strength

| | | | |
|---|---|---|---|
| 7 day sc quarry tile/plywood shear strength | 100 | 180 | na |
| 28 day sc quarry tile/plywood shear strength | 150 | 195 | 283 |

TABLE 3
ANSI A118.4 Open Time results.
ANSI A 118.4 Open Time (PSI)

| | WPC-P.A | | SBB-Inv. | |
|---|---|---|---|---|
| | 20 min | 30 min | 20 min | 30 min |
| | 171 | 148 | 95 | 117 |
| | 148 | 164 | 139 | 123 |
| | 171 | 147 | 106 | 81 |
| | 133 | 94 | 103 | 92 |
| | 192 | 103 | 128 | 38 |
| | 183 | 130 | 131 | 97 |
| | 157 | 157 | 127 | 89 |
| | 162 | 138 | 116 | 88 |
| avg | 165 | 135 | 118 | 91 |
| std | 19 | 25 | 16 | 26 |

TABLE 4
Heliopath Viscosity Results.
Heliopath Viscosity Test

| | WPC-P.A | SBB-Inv. |
|---|---|---|
| Viscosity (cP) | 600,800 | 636,300 |
| std | 34,770 | 53,820 |

TD (94) @ 2 RPM (0-1,000,000 cP)

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A Portland cement-free binder formulation for building materials comprising:
a geopolymer material present in an amount from greater than 90 wt. % to 98 wt. % of the binder formulation;
an activator agent comprising a first lime component, the activator agent first lime component comprising hydrated lime present in an amount from greater than 0 wt. % to less than 10 wt. % of the binder formulation,
a slag accelerating agent comprising a second lime component, the slag accelerating agent second lime component comprising calcium dihydroxide and a calcium salt present in an amount from greater than 0 wt. % to less than 10 wt. % of the binder formulation;
wherein wt. % is based on a total weight of the binder formulation.

2. A Portland cement-free binder formulation for building materials comprising:
a slag material present in an amount from greater than 90 wt. % to 98 wt. % of the binder formulation;
an activator agent comprising a first lime component, the activator agent first lime component comprising hydrated lime present in an amount from about 1-9 wt. % of the binder formulation,
a slag accelerating agent comprising a second lime component, the slag accelerating agent second lime component comprising at least calcium dihydroxide in combination with calcium disulphamate present in an amount from about 1-9 wt. % of the binder formulation;
wherein wt. % is based on a total weight of the binder formulation.

3. The binder of claim 2 wherein the slag comprises bulk slag selected from the group consisting of granulated ground blast furnace slag (GGBFS), blast furnace slag, slag type 120, ferrous metal slag, and finely ground GGBFS.

4. The binder of claim 2 wherein the hydrated lime activator agent comprises calcium hydroxide, calcium-magnesium hydroxide, dolomitic hydrated lime, dolomitic calcium hydroxide, >50% calcium hydroxide, or >35% magnesium hydroxide, hydrated lime type S, or hydrated lime type N.

5. (canceled)

6. The binder of claim 2 wherein the calcium dihydroxide is present in an amount of 1-20 wt. % and the calcium disulphamate is present in an amount of 10-60 wt. % and, based on a total weight of the slag accelerating agent.

7. The binder of claim 2 wherein the binder formulation is a premixed hydrated lime activated slag-based binder and is mixed with one or more additional compounds for rendering a building material composition.

8. (canceled)

9. The binder of claim 7 wherein the rendered building material composition is selected from the group consisting of a tile adhesive, mortar, thin-set mortar, self-leveling underlayment, thin-set adhesive, grout, patch, and other and other cementitious construction materials.

10. The binder of claim 7 wherein the slag material is present in an amount of about 15-50 wt. % of the building material composition; the activator agent is present in an amount of about 1-20 wt. % of the building material composition, and the slag accelerating agent is present in an amount of about 0.25-5 wt. % of the building material composition, wherein wt. % is based on a total weight of the building material composition.

11. The binder of claim 7 wherein the one or more additional compounds are selected from the group consisting of a dispersible powder copolymer, one or more rheological modifier additives, water reducing agents, one or more defoamers, limestone, sand, and one or more additional accelerating agents.

12. The binder of claim 11 wherein the one or more additional compounds comprises a dispersible powder copolymer present in an amount from equal to or greater than 0 wt. % to 10 wt. %.

13. The binder of claim 11 wherein the one or more additional compounds comprises a one or more rheological modifier additives present in an amount from equal to or greater than 0 wt. % to 1 wt. %.

14. The binder of claim 13 wherein the one or more rheological modifier comprises cellulose ether, a material designed for cementitious material, modified hydroxypropyl methyl cellulose ether, hydroxypropyl ethyl cellulose ether, and dituan gum-based viscosity modifier.

15. The binder of claim 11 wherein the one or more additional compounds comprises a water reducing agent present in an amount from equal to or greater than 0 wt. % to 1 wt. %, the water reducing agent comprises superplasticizers selected from the group consisting of polycarboxylate ether, melamine sulfonates, naphthalene sulfonates, and/or lignosulfonates.

16. (canceled)

17. The binder of claim 11 wherein the one or more additional compounds comprises limestone present in an amount from equal to or greater than 0 wt. % to 10 wt. %.

18. The binder of claim 11 wherein the one or more additional compounds comprises sand present in an amount ranging from 30-70 wt. %.

19. The binder of claim 11 wherein the one or more additional compounds comprises one or more additional accelerating agents present in an amount from equal to or greater than 0 wt. % to 10 wt. % selected from the group consisting of sodium silicate, sodium hydroxide sodium carbonate, potassium silicate potassium hydroxide, potassium carbonate, organic calcium salts including calcium acetate calcium formate calcium sulfamate, and calcium sulfate

20. (canceled)

21. A Portland cement-free building material composition comprising:
the Portland cement-free binder formulation of claim 1, wherein the slag material of the binder formulation is present in an amount from about 15-50 wt. % based on a total weight of the building material composition,
the activator agent first lime component is present in an amount from about 1-20 wt. % based on the total weight of the building material composition, and the
slag accelerating agent second lime component is present in an amount from about 0.25-5 wt. % based on the total weight of the building material composition;
a redispersable powdered copolymer of vinyl acetate ethylene in an amount of equal to or greater than 0 wt. % to 10 wt. %;
cellulose ether in an amount of equal to or greater than 0 wt. % to 1 wt. %;
limestone in an amount of equal to or greater than 0 wt. % to 10 wt. % wt.%; and
sand in an amount of about 40-70 wt. %,
wherein all wt. % is based on the total weight of the building material composition.

22. The composition of claim 21 further comprising:
a second rheological modifier of dituan gum-based viscosity modifier in an amount of equal to or greater than 0 wt. % to 1 wt. %;
a water reducer, flow additive in an amount of equal to or greater than 0 wt. % to 1 wt. %;
a defoamer in an amount of equal to or greater than 0 wt. % to 1 wt. %;
wherein all wt. % is based on the total weight of the building materials composition.

23. (canceled)

24. The composition of claim 22 further comprising:
limestone in an amount of equal to or greater than 0 wt. % to 10 wt. % wt. %;
wherein all wt. % is based on the total weight of the building composition.

25. The composition of claim 21 wherein the Portland cement-free building material composition comprises a tile adhesive or mortar composition.
